(19) United States
(12) Patent Application Publication
(10) Pub. No.: US 2015/0220627 A1
(43) Pub. Date: Aug. 6, 2015

(54) SYSTEM AND METHOD FOR FINDING COLLECTIVE INTEREST-BASED SOCIAL COMMUNITIES

(71) Applicant: International Business Machines Corporation, Armonk, NY (US)

(72) Inventors: Hemank Lamba, New Delhi (IN); Natwar Modani, Gurgaon (IN)

(73) Assignee: International Business Machines Corporation, Armonk, NY (US)

(21) Appl. No.: 14/172,512

(22) Filed: Feb. 4, 2014

(51) Int. Cl. G06F 17/30; G06F 11/14

(52) U.S. Cl. CPC G06F 17/30705; G06F 11/1402

(57) ABSTRACT

Methods and arrangements for discerning collective interests among communities. A contemplated method includes accepting input comprising: a population of entities, a collection of objects and/or topics, connectivity information among the population of entities, and data relative to an expression of interest of each of the entities in the objects and/or topics; constructing a social network graph among the entities by representing the entities as nodes in the graph and connectivity between the entities as edges in the graph; associating, with each of the entities, the data relative to an expression of interest in the objects and/or topics; defining, relative to the social network graph, separate parameters for social connectivity and collective interests; defining a relative importance parameter for social connectivity and collective interests; defining an objective function based on the social connectivity parameter, the collective interests parameter, and the relative importance parameter; and discerning at least one collective interest-based social community via optimizing the objective function. Other variants and embodiments are broadly contemplated herein.

### BACKGROUND

Generally, finding collective interest-based social communities that have a clear preference behavior for certain items or topics, such as communities within social networks or other networks, represents a worthy challenge for a variety of applications.

Within this broad umbrella, “focused communities” can be defined as groups of people that show a marked preference for certain items or topics of interest, and are socially well-connected. “Like-minded communities” (LMCs) can be regarded as somewhat similar to focused communities, and can be defined as groups of people that are socially well-connected and have similar interests. As one can appreciate, information on focused communities and LMCs can be very useful for running marketing campaigns that leverage the “word-of-mouth” effect, for example, a viral marketing campaign.

One may also define differentiated interest communities as groups of social network participants that collectively have markedly different preferences than a reference group (e.g., which could be the overall population). Such communities can be useful from a marketing point of view. Similarly, one may find the discovery of balanced-preference communities of substantial benefit; these can be defined as groups of people that collectively present well-spread interests in items, objects and/or topics.

Conventionally, methods of finding focused communities are not well-represented and, as such, tend to present several drawbacks. One commonly encountered problem is slowness, such that it may become necessary to run expensive graph algorithms on each of several product-induced subgraphs. Another problem emerges in a lack of control by the user over any trade-off between community like-mindedness and social connectivity; generally, the user is only able to directly influence the number of people who would be assigned to some like-minded community. In other words, the trade-off is between the number of people that can be assigned to communities, and the level of like-mindedness of the communities. Thus, it often emerges that like-minded communities defined conventionally tend to have only a small number of people, and thus are of questionable practical use. Conventional algorithmic approaches generally fail to make up for the shortcomings so encountered.

### BRIEF SUMMARY

In summary, one aspect of the invention provides a method of discerning collective interest-based social communities, the method comprising: accepting input comprising: a population of entities, a collection of objects and/or topics, connectivity information among the population of entities, and data relative to an expression of interest of each of the entities in the objects and/or topics; constructing a social network graph among the entities by representing the entities as nodes in the graph and connectivity between the entities as edges in the graph; associating, with each of the entities, the data relative to an expression of interest in the objects and/or topics; defining, relative to the social network graph, separate parameters for social connectivity and collective interests; defining a relative importance parameter for social connectivity and collective interests; defining an objective function based on the social connectivity parameter, the collective interests parameter, and the relative importance parameter, and discerning at least one collective interest-based social community via optimizing the objective function.

Another aspect of the invention provides an apparatus for discerning collective interest-based social communities, said apparatus comprising: at least one processor; and a computer readable storage medium having computer readable program code embodied therewith and executable by the at least one processor, the computer readable program code comprising: computer readable program code configured to accept input comprising: a population of entities, a collection of objects and/or topics, connectivity information among the population of entities, and data relative to an expression of interest of each of the entities in the objects and/or topics; computer readable program code configured to construct a social network graph among the entities by representing the entities as nodes in the graph and connectivity between the entities as edges in the graph; computer readable program code configured to associate, with each of the entities, the data relative to an expression of interest in the objects and/or topics; computer readable program code configured to define, relative to the social network graph, separate parameters for social connectivity and collective interests; computer readable program code configured to define a relative importance parameter for social connectivity and collective interests; computer readable program code configured to define an objective function based on the social connectivity parameter, the collective interests parameter, and the relative importance parameter; and computer readable program code configured to discern at least one collective interest-based social community via optimizing the objective function.

An additional aspect of the invention provides a computer program product for discerning collective interest-based social communities, the apparatus comprising: a computer readable storage medium having computer readable program code embodied therewith, the computer readable program code comprising: computer readable program code configured to accept input comprising: a population of entities, a collection of objects and/or topics, connectivity information among the population of entities, and data relative to an expression of interest of each of the entities in the objects and/or topics; computer readable program code configured to construct a social network graph among the entities by representing the entities as nodes in the graph and connectivity between the entities as edges in the graph; computer readable program code configured to associate, with each of the entities, the data relative to an expression of interest in the objects and/or topics; computer readable program code configured to define, relative to the social network graph, separate parameters for social connectivity and collective interests; computer readable program code configured to define a relative importance parameter for social connectivity and collective interests; computer readable program code configured to define an objective function based on the social connectivity parameter, the collective interests parameter, and the relative importance parameter, and computer readable program code configured to discern at least one collective interest-based social community via optimizing the objective function.

A further aspect of the invention provides a method comprising: accepting as input a population of entities, a collection of objects and/or topics, connectivity information among the population of entities, and data relative to an expression of interest of each of the entities in the objects and/or topics; constructing a social network graph among the entities by representing the entities as nodes in the graph and connectivity between the entities as edges in the graph; associating, with each of the entities, the data relative to an expression of interest in the objects and/or topics; defining, relative to the social network graph, separate parameters for social connectivity and collective interests, the collective interest parameter relating to aggregate interests of a group of nodes in the social network graph in the objects and/or topics; defining a relative importance parameter for social connectivity and collective interests, the relative importance parameter governing a trade-off between social connectivity and collective interests; defining an objective function based on the social connectivity parameter, the collective interests parameter the relative importance parameter, and a social connectivity function which captures a quality of partitioning of the nodes of the network into groups; and discerning at least one collective interest-based social community via optimizing the objective function; the optimizing of the objective function comprising: for each edge present in the social network graph, evaluating a gain from combining the pair of nodes defining the edge; determining a maximum gain from the evaluating, and designating an associated edge; combining the pair of nodes of the associated edge into a single community if the maximum gain is positive and above a predetermined threshold; and repeating the steps of evaluating, determining a maximum gain and combining until there is no positive maximum gain above the predetermined threshold.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 sets forth an example table of product purchase data, or an expressed interest in an item, for a group of people.

FIG. 2 schematically illustrates a social network of the same sample group of people depicted in FIG. 1.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

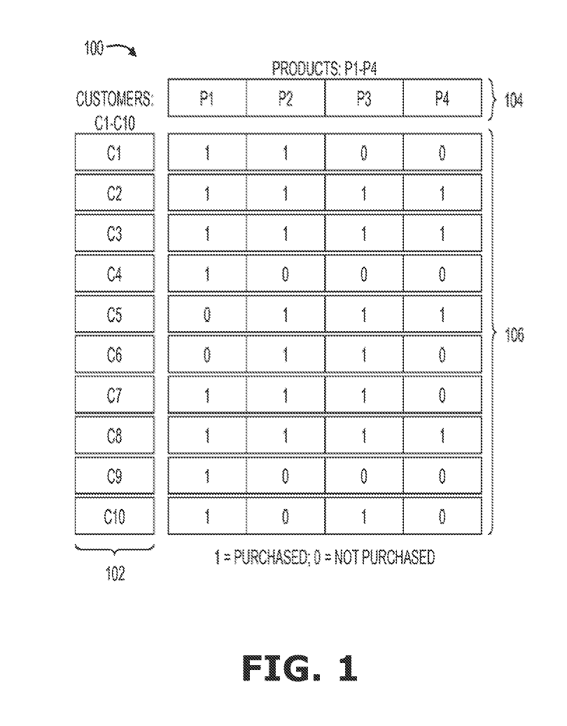

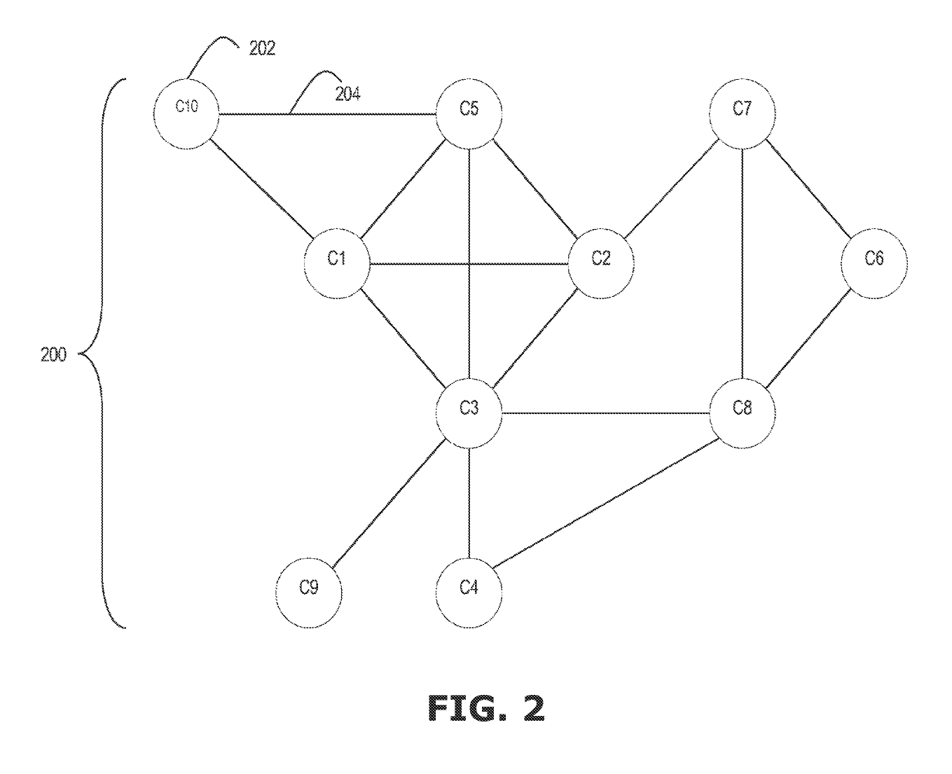

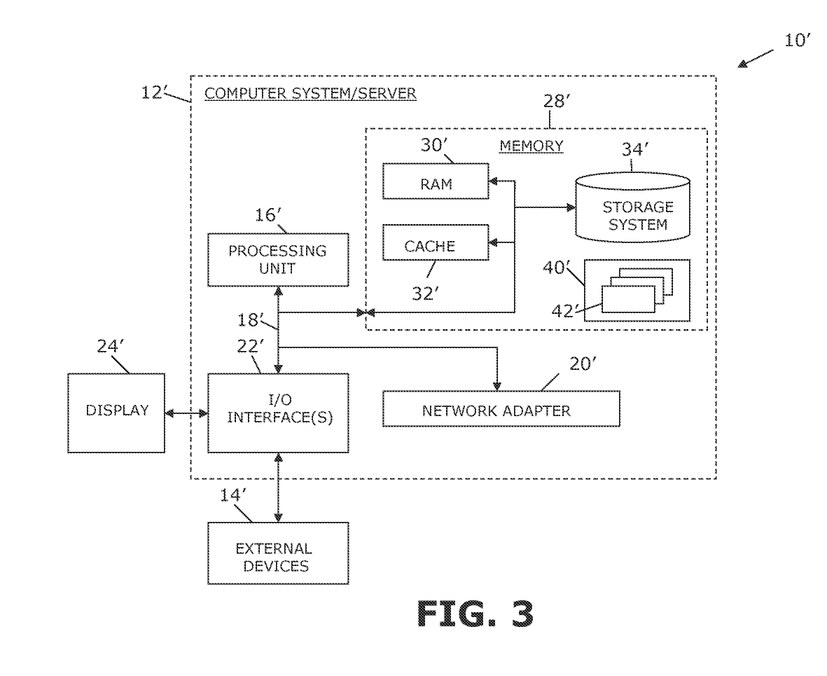

Specific reference will now be made herebelow to FIGS. 1 and 2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1 and 2 can be performed or utilized by way of a processing unit or units and system memory such as those indicated, respectively, at 16′ and 28′ in FIG. 3, whether on a server computer, a client computer, a node computer in a distributed network, or any combination thereof.

General background information on like-minded community finding may be found, for instance, in commonly assigned and co-pending U.S. patent application Ser. No. 13/171,594 (published as U.S. Publication No. 2013/0006880 on Jan. 3, 2013) and Ser. No. 13/597,569 (published as U.S. Publication No. 20130006796 on Jan. 3, 2013), both entitled “Method for Finding Actionable Communities Within Social Networks”. FIGS. 1 and 2, as presented herein, provide a general context in which at least one embodiment of the invention may be employed.

Accordingly, by way of conveying a general context associated with at least one embodiment of the invention, FIG. 1 illustrates a table 100 of product purchase data (or, alternatively, an expressed interest in an item) relative to people 102, (customers C1-C10). Merely by way of illustration, the table shows purchase data, among people 102, relative to a specific number of products 104 (products P1-P4). In section 106 of table 100, a “1” represents that a customer has purchased a product in the associated column, while a “0” represents that a customer has not purchased a product in the associated column.

Further, by way of conveying a general context associated with at least one embodiment of the invention, FIG. 2 illustrates, generally at 202 and represented by the circles labeled C1-C10, an underlying social network 200 of the customers (102) from FIG. 1. Lines 204 between customers represent customer associations within the social network. Thus, for each customer:
C1 is associated with C2, C3, C5 and C10;
C2 is associated with C1, C3, C5 and C7;
C3 is associated with C1, C2, C4, C5 and C9;
C4 is associated with C3 and C8;
C5 is associated with C1, C2, C3 and C10;
C6 is associated with C7 and C8;
C7 is associated with C2, C6 and C8;
C8 is associated with C3, C4, C6 and C7;
C9 is associated with C3; and
C10 is associated with C1 and C5.
   It should be understood that the example conveyed via FIGS. 1 and 2 is provided solely for purposes of illustration, and represents but one possible context in which embodiments of the invention may be employed. Generally, embodiments of the invention may be employed in connection with entities that may include people who potentially may form part of a community; customers are merely presented herein as one example of such entities.

Broadly contemplated herein, in accordance with at least one embodiment of the invention, is an optimization-based framework for focused community finding, with a parameter to control the trade-off between the focus (or fine definition) of the communities and social connectivity. The objective function is of the form

max M*x+F*(1−x),

where, for instance, F is a “focusedness” function and M is a social connectivity measure. Generally, M can represent a known modularity measure and x represents the relative importance of modularity and like-mindedness (between, and including, 0 and 1). For instance, if x=0, then the objective function is equal to the modularity value (M) and if x=1, then the objective function is equal to the focusedness function F; otherwise, the objective function is a linear combination of the two factors. The modularity metric M measures the strength of division of a network into modules, groups or communities. It is defined as the difference between actual number of edges between nodes in the same community and the expected number of edges between them. Mathematically, M is defined as follows:

$$M = {\sum }_{ij} [ \frac{{A}_{ij}}{2 m} - \frac{{k}_{i} * {k}_{j}}{( 2 m ) ( 2 m )} ] δ ( {c}_{i} , {c}_{j} )$$

Here, m represents the number of edges in the graph representing the social network, A is an adjacency matrix of that graph, capturing which nodes are connected to which other nodes, and kᵢ and kⱼ denote the degree of nodes i and nodes j, cᵢ is the community that the node i belongs to; consequently, the quantity δ(cᵢ, cⱼ) is 1 if node i and node j belong to the same community, else it is equal to 0. For background purposes, a general definition of modularity can be found in Newmann M. E. J, “Modularity and Community Structure in networks”, Proceedings of the National Academy of Sciences (PNAS) 103 (23): 8577-8582, 2006. For its part, it can be appreciated that the function F (noted further above) is defined in such a way that it is dependent on only the aggregate interests or purchases of a group of individuals in a network.

The discussion now turns to examples of a like-mindedness function F, in accordance with at least one embodiment of the invention. As such, using purchases as an example, let the quantity purchased by a person vᵢ of item mⱼ be denoted by qᵢⱼ, which can be summarized by the vector qᵢ. Also, let C represent a group of people, and let Q(C) denote the vector of collective purchases of this community C, hence Qⱼ(C) represents the quantity of the item mⱼ purchased by the community C. That is,

$${Q}_{j} ( C ) = {Σ}_{i} {q}_{ij} δ ( {v}_{i} , C ) , \\ \begin{matrix}where δ ( {v}_{i} , C ) = 1 and , \\ = 0 otherwise .\end{matrix}$$

In accordance with at least one embodiment of the invention, let pⱼ(C) denote the probability that a unit of item purchased by the community C is of item type mⱼ, which can be computed as:

$${p}_{j} ( C ) = \frac{{Q}_{j} ( C )}{{Σ}_{i} {Q}_{i} ( C )} ,$$

i.e., the number of units of item type mⱼ normalized by the number of total units (across all items) purchased by the community C. The entropy of the group is then defined as:

H(C)=Σⱼpⱼ(C)*log pⱼ(C)

Further, the like-mindedness of a group is defined as:

$${L}_{C} = \frac{1}{1 + H ( C )}$$

It can be appreciated that, in accordance with at least one embodiment of the invention, formulations such as those described herein can prove to be useful in that they are dependent only on aggregate information relating to purchases (or interests), which permits a class of algorithms to solve the problem in an effective manner. For example, the objective function referred to herein is amenable to being solved using CNM (Clauset, Newman and Moore) and BGLL (Blondel-Guillaume-Lambiotte-Lefebvre) algorithms. (For background reference purposes, the CNM algorithm is described in “Finding Community Structure in Very Large Networks”, Phys. Rev. E 70, 066111 (2004), while the BGLL algorithm is described in “Fast Unfolding of Communities in Large Networks, J. Sta. Mech., P10008 (2008).)

Also, one can try to find the most distinguished communities, by taking the function F as a function of the KL-divergence (Kullback-Leibler divergence) between information relating to global purchases (or interests) and community-level purchases (or interests). KL-divergence, also known as information divergence, is a measure between two probability distributions. It is said to denote the information lost when one distribution is used to approximate the other distribution. (For background reference purposes, KL divergence has been explained in Kullback, S.: Leibler, R. A. “On Information And Sufficiency”, Annals of Mathematical Statistics 22(1): 79-86 (1951).)

In accordance with at least one embodiment of the invention, one may also wish to find communities with most diverse interests, rather than most focused communities. In that case, the function F can be accepted as an inversely related function from its definition further above, i.e., it can be taken as F=1−L_{C}. Thus, embodiments of the invention can be employed to find any of a great variety of different communities, and not simply focused or like-minded communities.

It can also be appreciated that in stark contrast to at least one embodiment of the invention, conventional definitions of like-mindedness of a pair of people are defined as a cosine similarity of interests, and like-mindedness of a set of communities is tied to all-pair similarity. This cannot be updated easily, and this emerges as a disadvantage as such updating may otherwise be useful or required in settings such as those employing hierarchical agglomerative approach (somewhat similar to the CNM method, with the difference that CNM algorithm only takes modularity into account) or neighborhood search approach (somewhat similar to BGLL algorithm, with the difference that BGLL algorithm only takes modularity into account).

By way of further elaboration in accordance with at least one embodiment of the invention, a hierarchical agglomerative algorithm and neighborhood search algorithm can be defined relative to the objective function defined herein. As such, the hierarchical agglomerative algorithm evaluates, for each edge in the network, as to whether combining the two terminal nodes of the edge gives an increase in the objective function (assuming here that the objective function is a convex function of focusedness and of a structural function, e.g., modularity). The algorithm then combines the nodes for that edge which provides the maximum gain in the objective function. These nodes are now considered to be part of the same community, and the resulting community is treated as a single node. The edges connecting to the two vertices (which themselves may or may not already be defined as communities) are consolidated to the newly created node. These steps are repeated until there is no significant gain possible by combining two nodes, or any such gain would only be negative.

By way of further elaboration in accordance with at least one embodiment of the invention, a neighborhood search approach involves initializing each node as belonging to separate communities. Then, for each node, an evaluation is made as to whether there is an increase in the objective function value by moving the node from its present community to another other community where at least one of the neighbors of the node is present. The node is then moved to the community of the neighboring node for which the increase in the objective function is the maximum (and is positive). If there is no increase possible in the objective function value by moving the node, it is not moved. This process is repeated until there is no gain by moving any node to any other community. Once there is an end to checking all the potential transfers of nodes, all the nodes of a community merged into a single node and a “super graph” is created by consolidating the edges between these merged-community nodes. The steps defined above are then undertaken on the super graph until no nodes can be merged any further.

Referring now to FIG. 3, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method of discerning collective interest-based social communities, said method comprising:
accepting input comprising: a population of entities, a collection of objects and/or topics, connectivity information relative to entities among the population of entities, and data indicating an expression of interest in the objects and/or topics by each of the entities;
constructing a social network graph among the entities by representing the entities as nodes in the graph and connectivity between the entities as edges in the graph;
defining, relative to the social network graph, separate parameters for social connectivity and collective interests;
defining a single relative importance parameter which indicates a relative importance, with respect to one another, of the social connectivity parameter and the collective interests parameter;
defining an objective function based on the social connectivity parameter, the collective interests parameter, and the relative importance parameter; and
discerning at least one collective interest-based social community via optimizing the objective function.

2. The method according to claim 1, wherein the collective interest parameter relates to aggregate interests of a group of nodes in the social network graph in the objects and/or topics, and captures a preference of the group of nodes for one or more of the objects and/or topics.

3. The method according to claim 2, wherein the relative importance parameter governs a trade-off between social connectivity and collective interests.

4. The method according to claim 3, wherein the objective function comprises a social connectivity function which relates to a quality of partitioning of the nodes of the network into groups.

5. The method according to claim 2, wherein a value of the collective interest function is (i) higher if the group of nodes shows preference for a smaller number of objects and/or topics and/or (ii) lower if the group of nodes shows uniform preference for a larger number of objects and/or topics.

6. The method according to claim 2, wherein:
the collective interest function represents a differentiation of interests of the group of nodes relative to another, reference group of entities; and
a value of the collective interest function is (i) higher if the group of nodes shows a different preference for one or more objects and/or topics as compared to the reference group, and/or (ii) lower if the group of nodes shows similar preference for one or more objects and/or topics as compared to the reference group.

7. The method according to claim 6, wherein the reference group comprises the entire population of the entities.

8. The method according to claim 2, wherein:
the collective interest function represents a uniformity of the interests of the group of nodes in the objects and/or topics; and
a value of the collective interest function is (i) higher if the group of nodes shows similar preference for a large number of objects and/or topics, and/or (ii) lower if the group of nodes shows a marked preference for a smaller number of objects and/or topics.

9. The method according to claim 1, wherein said optimizing of the objective function comprises:
for each edge present in the social network graph, evaluating a gain from combining the pair of nodes defining the edge;
determining a maximum gain from said evaluating, and designating an associated edge;
combining the pair of nodes of the associated edge into a single community if the maximum gain is positive and above a predetermined threshold; and
repeating said steps of evaluating, determining a maximum gain, and combining, until there is no positive maximum gain above the predetermined threshold.

10. The method, according to claim 1, wherein said optimizing comprises:
initializing each node in the social network graph as belonging to separate communities;
for each node, evaluating whether there is an increase in the value of the objective function value by moving the node from its present community to a different community, the different community including at least one neighbor node;
determining the maximum increase from said evaluating step, and designating an associated node;
moving the associated node to its different community including at least one neighbor node, only if the maximum increase is positive and above a predetermined threshold;
repeating said steps of evaluating, determining a maximum increase, and moving, until there is no positive maximum increase above the predetermined threshold;
with respect to each community now defined, merging all nodes of the community into a single new node;
establishing a super graph via consolidating edges between the new nodes; and
repeating said steps of evaluating, determining a maximum increase, moving, repeating, and establishing a super graph, until no nodes can be merged any further.

11. An apparatus for discerning collective interest-based social communities, said apparatus comprising:
at least one processor; and
a computer readable storage medium having computer readable program code embodied therewith and executable by the at least one processor, the computer readable program code comprising:
computer readable program code configured to accept input comprising: a population of entities, a collection of objects and/or topics, connectivity information relative to entities among the population of entities, and data indicating an expression of interest in the objects and/or topics by each of the entities;
computer readable program code configured to construct a social network graph among the entities by representing the entities as nodes in the graph and connectivity between the entities as edges in the graph;
computer readable program code configured to define, relative to the social network graph, separate parameters for social connectivity and collective interests;
computer readable program code configured to define a single relative importance parameter which indicates a relative importance, with respect to one another, of the social connectivity parameter and the collective interests parameter;
computer readable program code configured to define an objective function based on the social connectivity parameter, the collective interests parameter, and the relative importance parameter; and
computer readable program code configured to discern at least one collective interest-based social community via optimizing the objective function.

12. A computer program product for discerning collective interest-based social communities, said apparatus comprising:
a computer readable storage medium having computer readable program code embodied therewith, the computer readable program code comprising:
computer readable program code configured to accept input comprising: a population of entities, a collection of objects and/or topics, connectivity information relative to entities among the population of entities, and data indicating an expression of interest in the objects and/or topics by each of the entities;
computer readable program code configured to construct a social network graph among the entities by representing the entities as nodes in the graph and connectivity between the entities as edges in the graph;
computer readable program code configured to define, relative to the social network graph, separate parameters for social connectivity and collective interests;
computer readable program code configured to define a single relative importance parameter which indicates a relative importance, with respect to one another, of the social connectivity parameter and the collective interests parameter;
computer readable program code configured to define an objective function based on the social connectivity parameter, the collective interests parameter, and the relative importance parameter; and
computer readable program code configured to discern at least one collective interest-based social community via optimizing the objective function.

13. The computer program product according to claim 12, wherein the collective interest parameter relates to aggregate interests of a group of nodes in the social network graph in the objects and/or topics, and captures a preference of the group of nodes for one or more of the objects and/or topics.

14. The computer program product according to claim 13, wherein the relative importance parameter governs a trade-off between social connectivity and collective interests.

15. The computer program product according to claim 14, wherein the objective function comprises a social connectivity function which relates to a quality of partitioning of the nodes of the network into groups.

16. The computer program product according to claim 13, wherein a value of the collective interest function is (i) higher if the group of nodes shows preference for a smaller number of objects and/or topics and (ii) lower if the group of nodes shows uniform preference for a larger number of objects and/or topics.

17. The computer program product according to claim 13, wherein:
the collective interest function represents a differentiation of interests of the group of nodes relative to another, reference group of entities; and
a value of the collective interest function is (i) higher if the group of nodes shows a different preference for one or more objects and/or topics as compared to the reference group, and/or (ii) lower if the group of nodes shows similar preference for one or more objects and/or topics as compared to the reference group.

18. The computer program product according to claim 17, wherein the reference group comprises the entire population of the entities.

19. The computer program product according to claim 13, wherein:
the collective interest function represents a uniformity of the interests of the group of nodes in the objects and/or topics; and
a value of the collective interest function is (i) higher if the group of nodes shows similar preference for a large number of objects and/or topics, and/or (ii) lower if the group of nodes shows a marked preference for a smaller number of objects and/or topics.

20. A method comprising:
input comprising: a population of entities, a collection of objects and/or topics, connectivity information relative to entities among the population of entities, and data indicating an expression of interest in the objects and/or topics by each of the entities;
constructing a social network graph among the entities by representing the entities as nodes in the graph and connectivity between the entities as edges in the graph;
defining, relative to the social network graph, separate parameters for social connectivity and collective interests, the collective interest parameter relating to aggregate interests of a group of nodes in the social network graph in the objects and/or topics;
defining a single relative importance parameter which indicates a relative importance, with respect to one another, of the social connectivity parameter and the collective interests parameter;
defining an objective function based on the social connectivity parameter, the collective interests parameter the relative importance parameter, and a social connectivity function which captures a quality of partitioning of the nodes of the network into groups; and
discerning at least one collective interest-based social community via optimizing the objective function;
said optimizing of the objective function comprising:
for each edge present in the social network graph, evaluating a gain from combining the pair of nodes defining the edge;
determining a maximum gain from said evaluating, and designating an associated edge;
combining the pair of nodes of the associated edge into a single community if the maximum gain is positive and above a predetermined threshold; and
repeating said steps of evaluating, determining a maximum gain and combining until there is no positive maximum gain above the predetermined threshold.
